(19) United States
(12) Patent Application Publication
(10) Pub. No.: US 2021/0362509 A1
(43) Pub. Date: Nov. 25, 2021

(54) ALIGNMENT PATTERNS

(71) Applicant: HEWLETT-PACKARD DEVELOPMENT COMPANY, L.P., Spring, TX (US)

(72) Inventor: Li Qian, Sant Cugat del Valles (ES)

(21) Appl. No.: 16/604,555

(22) PCT Filed: Jul. 2, 2018
(86) PCT No.: PCT/US2018/040613

§ 371 Date: Oct. 10, 2019

(51) Int. Cl. B41J 2/21; B41J 29/393

(52) U.S. Cl. CPC B41J 2/2135; B41J 2029/3935; B41J 29/393

(57) ABSTRACT

A media may comprise an alignment pattern on a surface of the media, the alignment pattern comprising a first set of marks of a first color, and a plurality of reference areas covering at least partially the first set of marks and the reference areas having a plurality of gaps. The reference areas may be a second colour, wherein the second colour is different to the first colour. The reference areas may be formed of an printing fluid such that the first set of marks underneath the reference areas are less detectable than one of the first set of marks in one of the plurality of gaps. The one of the first set of marks that is more detectable indicates a measure of alignment between the first set of marks and the reference areas.

### BACKGROUND

Alignment patterns may be used to detect misalignment when printing onto various print targets.

### BRIEF DESCRIPTION OF THE DRAWINGS

Examples are further described hereinafter with reference to the accompanying drawings, in which

FIG. 1 is an illustration of an alignment pattern according to some examples.

FIG. 2 is a further illustration of an alignment pattern according to some examples.

FIG. 3 is a further illustration of an alignment pattern according to some examples.

FIG. 4a is an illustration of a portion of an alignment pattern on a print target according to some examples.

FIG. 4b is a further illustration of a portion of an alignment pattern on a print target according to some examples.

FIG. 5 is an illustration of a two-dimensional alignment pattern on a print target according to some examples.

FIG. 6 is an illustration of a method to print an alignment pattern according to some examples.

FIG. 7 is an illustration of processor comprising storage means to perform a method according to some examples.

FIG. 8 is an illustration of a system according to some examples.

### DETAILED DESCRIPTION

Alignment patterns may be used to allow misalignment between different printing fluids on a print target to be conveniently determined in order to, e.g., compensate for any misalignments determined. Alignment patterns may be graded using a scale to allow the magnitude of the misalignment to be determined. The magnitude may be determined by a user by eye and/or by an automated process. The scale may use an arbitrary unit, or may use a unit such as millimeters, centimeters, inches or any other suitable measure of distance. A Vernier-type pattern may be used as the alignment pattern.

A Vernier-type pattern may comprise a first set of vertical lines and a second set of vertical lines. The first set of vertical lines and the second set of vertical lines have a different periodicity and may be overlaid such that a user and/or an automated process may determine the magnitude of misalignment by observing which of the first set of vertical lines and the second set of vertical lines are most closely vertically aligned.

In printing applications, the first set of lines and the second set of lines may be printed on a substrate by respective print devices, e.g. print heads. The resulting pattern indicates the alignment between the print devices. However, in some examples it may be difficult to determine which of the first set of vertical lines and the second set of vertical lines are most closely vertically aligned, as the printing fluid which forms one of the sets of vertical lines may not be distinguishable from the surface of the print target. This may be because one of the printing fluids may be transparent, or because one of the printing fluids may have a similar color to the color of the print target, or any other suitable reason.

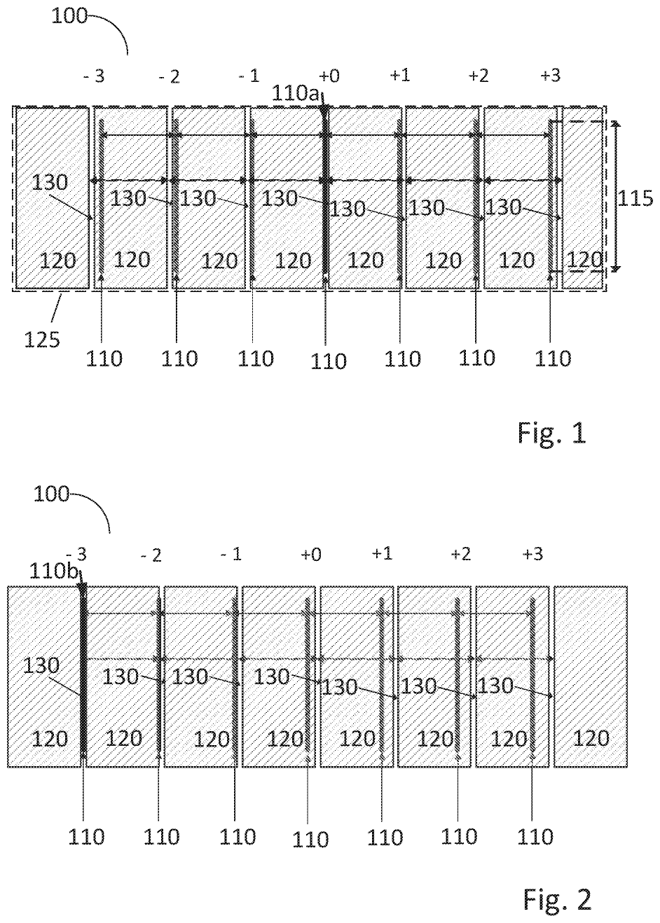

An illustration of an alignment pattern 100 according to some examples is provided by FIG. 1. The alignment pattern 100 may be formed on a print target. The alignment pattern 100 comprises a first set of marks 110 of first color and a plurality of reference areas 120 of a second color, the plurality of reference areas 120 at least partially covering the first set of marks 110 and the reference areas 120 forming a plurality of gaps 130. The second color may be different to the first color. The reference areas 120 are formed with a printing fluid such that each of the first set of marks 110 underneath the reference areas 130 are less detectable than the remainder of the first set of marks 110. The remainder 110a of the first set of marks which are not covered by the reference areas are more detectable than the areas that are covered by the reference areas 120. One of the remainder 110a of the first set of marks 110 in a gap between two adjacent reference areas 120 indicates a measure of alignment between the first set of marks and the reference areas.

The remainder 110a of the first set of marks 110 indicates the magnitude of the misalignment of the printing fluids in a direction of the alignment pattern 100, this direction may be deemed the alignment pattern direction. The alignment pattern direction in is the same direction as the periodicity of the alignment pattern 100. In FIG. 1, the remainder mark 110a indicates that the misalignment is 0 units in the direction of the alignment pattern 100, and therefore that that there is the misalignment is less than the division of the scale (e.g. less than 1 unit).

In some examples the level of detectability of each of the first set of marks 110 underneath the reference areas 130 is such that they are imperceptible to a user and/or a sensor. For example, it may be the case that each of the set of marks 110 underneath the reference areas 130 are detectable to a user, but a sensor is not able to detect the mark. Alternatively, the reverse may be true, that the each of the set of marks 110 underneath the reference areas 120 are detectable to a sensor, but that a user is not able to detect each of the set of marks 110 underneath the reference areas 130.

In some examples the level of detectability of each of the first set of marks 110 underneath the reference areas 130 is such that they are substantially imperceptible when viewing the print target from a viewing distance, such as from 10 cm, 20 cm, 30 cm, or 50 cm and the remainder mark 110a may be detectable from the same viewing distance.

In some examples the reference areas 120 may have a level of opacity such that the first set of marks 110 underneath the reference areas 120 are undetectable, or at least less detectable than the remainder of the first set of marks 110 which are not covered by the reference areas 120. In some examples the reference areas 120 may have a level of opacity such that the first set of marks underneath the reference areas 120 are not visible to a user and/or to a sensor.

FIG. 2 is a further illustration of the alignment pattern 100. FIG. 2 is substantially similar to FIG. 1, except for a difference in the magnitude of the misalignment of the first set of marks 110 and the plurality of reference areas 120. In FIG. 2, the remainder mark 110b detectable in the gap between two adjacent reference areas 120 indicates that the magnitude of the misalignment is −3 units.

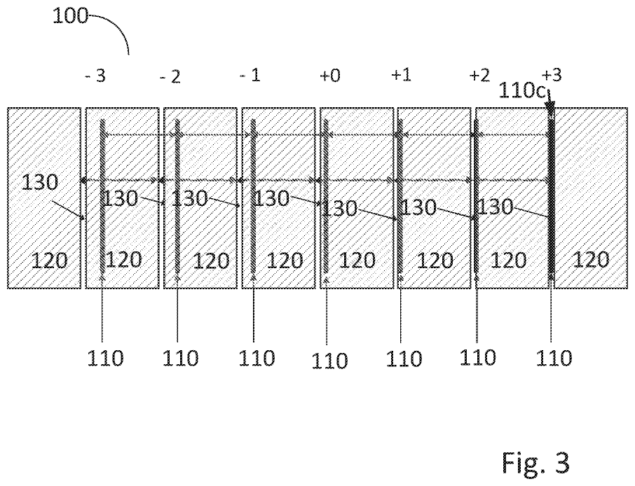

FIG. 3 is a further illustration of the alignment pattern 100. FIG. 3 is substantially similar to FIGS. 1 and 2, except for a difference in the magnitude of the misalignment of the first set of marks 110 and the plurality of reference areas 120. In FIG. 3, the remainder mark 110c detectable in the gap between two adjacent reference areas 120 indicates that the magnitude of the misalignment is +3 units.

FIGS. 1, 2 and 3 illustrate examples where the magnitude of the misalignment is 0 units, −3 units and +3 units. However, alignment pattern 100 may be used to determine the magnitude of the misalignment when the magnitude of misalignment is within the range of −3 units to 3 units, and may be used within a precision of 1 unit. A print target may comprise a plurality of alignment patterns, each alignment pattern may have a different scale and/or a different orientation so that alignment in different directions may be determined and/or to different precisions, for example a coarse and fine alignment. For example, in some examples a print target may comprise a first alignment pattern for coarse verification of the misalignment usable to determine misalignment up to a precision of tenths of centimeters, and a second alignment pattern usable to determine misalignment up to a precision of tenths of millimeters. However, it is not intended to be limited to the aforementioned values, and any number of alignment patterns and precision may be used.

In some examples, a single one of the first set of marks 110 is substantially detectable in the plurality of gaps formed by the plurality of reference areas 120 and the remainder of the first set of marks 110 are substantially undetectable in the plurality of gaps formed by the plurality of reference areas 120. In some examples a single one of the first set of marks 110 is detectable in the plurality of gaps formed by the plurality of reference areas 120 and the remainder of the first set of marks 110 are undetectable in the plurality of gaps formed by the plurality of reference areas 120. In some examples a single one of the first set of marks 110 is detectable and the remainder of the first set of marks 110 are undetectable. In some examples the one of the first set of marks 110 in one of the plurality of gaps is detectable in its entirety, such that the one of the first set of marks 110 is not covered by any of the reference areas 120.

FIGS. 1-3 illustrate the first set of marks 110 as having a height 115 that is shorter than the plurality of reference areas 120, and so do not extend out of the boundary 125 of the plurality of reference areas 120. The height of the first set of marks 110 may be defined as the direction perpendicular to the periodicity of the alignment pattern 100 or parallel to the alignment pattern direction. However, in some examples one or more of the first set of marks 110 may be longer than the plurality of reference areas 120 such that the one or more of the first set of marks 110 extends beyond the plurality of reference areas 120. In some examples height may be defined in the direction parallel to the media advance direction.

In some examples one of the first set of marks 110 substantially detectable in one of the plurality of gaps 130 may have a majority portion of the mark within the gap detectable. A majority portion may refer to more than 50% of the mark within the boundary 125 of the plurality of reference areas 120. In some examples the majority portion may refer to more than 75%, 90, 95%, or 99% of the mark within the boundary of the plurality of reference areas 120. The boundary 125 of the reference areas 120 is illustrated in FIG. 1, but is not shown in FIGS. 2 and 3. The boundary 125 is also illustrated as covering a larger area than the reference areas 120 for ease of viewing in FIG. 1.

FIGS. 1-3 illustrate the first set of marks 110 and the reference areas 120 as having a substantially rectangular shape, however the shape of the marks may not be rectangular. In some examples, the marks of the first set of marks 110 and/or the reference areas 120 may be blocks, crosses, lines, squares, stars or any suitable shape. The first set of marks 110 and the reference areas 120 may have the same shape or may have a different shape.

In some examples the alignment pattern 100 may form a Vernier style alignment pattern.

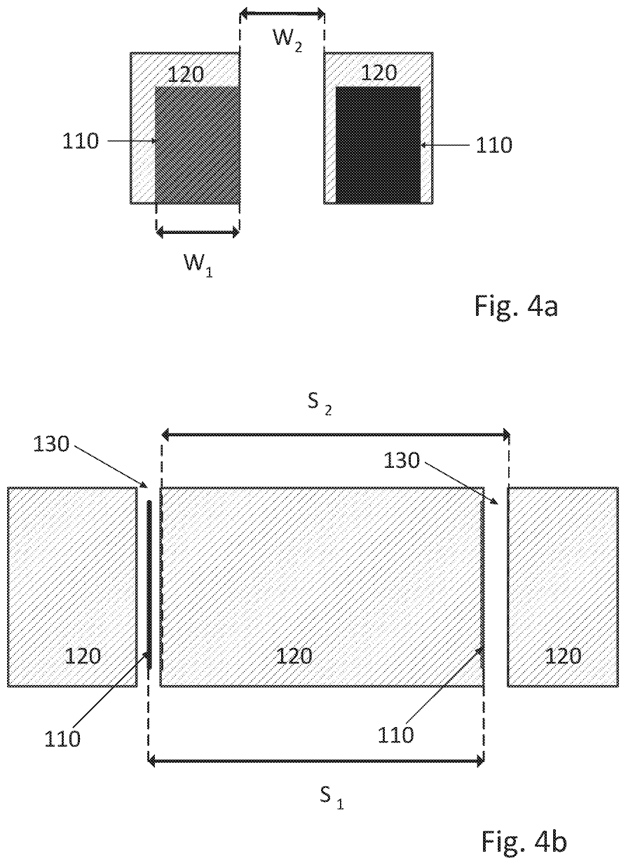

FIG. 4a illustrates and enlarged portion of the alignment pattern 100. In some examples each of the first set of marks 110 has a width W₁ and each of the plurality of gaps 130 have a width W₂. In some examples W₁ may be substantially equal to W₂. In some examples W₁ may be equal to W₂. In some examples W₂ may be larger than W₁. In some examples W₁ may be within a range of 1-2 mm, and W₂ may be within a range of 1-2 mm, although the ranges are not limited to the aforementioned values.

In some examples the first set of marks 110 may be regularly and/or periodically spaced. In some examples the plurality of reference areas 120 may be regularly and/or periodically spaced.

FIG. 4b also illustrates an enlarged portion of alignment pattern 100. The first set of alignment marks have a spacing S₁. The plurality of reference areas has a spacing S₂. The overall length of the alignment pattern may be equal to nS₁ where n is the number of marks of the first set of marks 110. S₂ may be chosen such that nS₁=(n−1)S₂. In some examples S₁ may be in the range 30-50 mm, and S₂ may be within the range 28-48 mm, although the ranges are not limited to the aforementioned values.

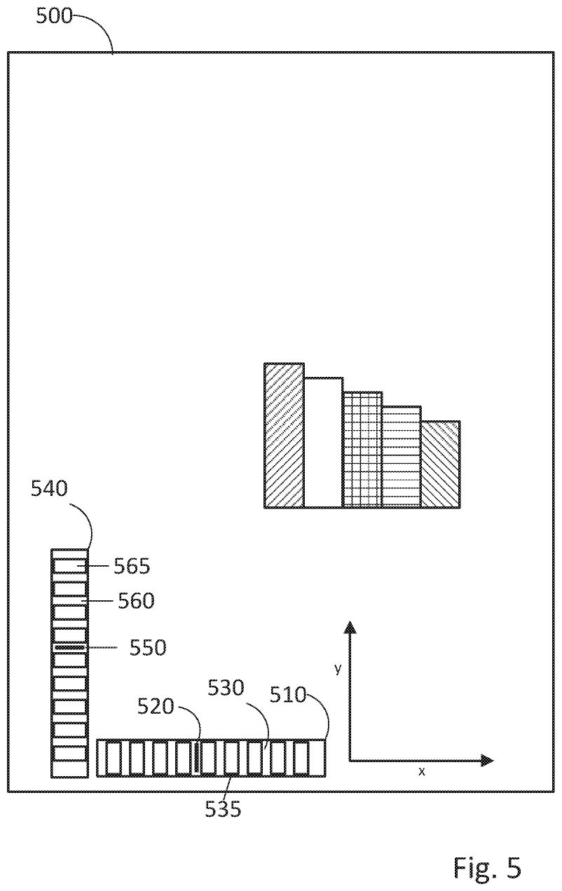

FIG. 5 illustrates a two-dimensional alignment pattern formed on a print target 500. The two-dimensional alignment pattern may be similar to the alignment pattern 100 described in relation to FIGS. 1-4b. The alignment pattern may comprise a first alignment pattern 510, the first alignment pattern comprising a plurality of first alignment marks 520 and a plurality of reference areas 535 forming a plurality of gaps 530. The first alignment pattern 510 may be used to determine the magnitude of the misalignment in the x direction of the print target. The two-dimension alignment pattern may be described as a two-dimensional alignment pattern as it allows the misalignment to be determined in two separate dimensions.

The two-dimensional alignment pattern may also comprise a second alignment pattern 540, the second alignment pattern comprising a plurality of first alignment marks 550 and a plurality of second alignment marks 560. The second alignment marks may be formed by printing a second plurality of reference areas 565. The first alignment pattern 510 may be used to determine the magnitude of the misalignment in the y direction of the print target.

The first alignment pattern 510 and the second alignment pattern 540 may be arranged orthogonal to each other, such that alignment in two dimensions may be determined. The two-dimensional alignment pattern is illustrated as comprising two one-dimensional alignment patterns, however the two-dimensional alignment pattern may comprise a grid of alignment marks. The scale of the two-dimensional alignment pattern may be substantially the same in both x and y dimensions or may be different. For example, if alignment in the x direction is more desirable than alignment in the y direction then a fine scale may be used in the x direction and a coarse scale in the y direction.

In some examples the color of the print target 500 may be substantially similar to the color of the first plurality of reference areas 535 and the second plurality of reference areas 565, such that the first plurality of reference areas 535 and the second plurality of reference areas 565 are substantially undetectable on the print target 500. The first plurality of reference areas 535 and the second plurality of reference areas 565 are such that any of the first alignment marks 520/550 underneath the first plurality of reference areas 535 and the second plurality of reference areas 565 are substantially undetectable.

In some examples the first plurality of reference areas 535 and the second plurality of reference areas 565 may be substantially formed of a white printing fluid. In some examples the print target may be white or substantially white.

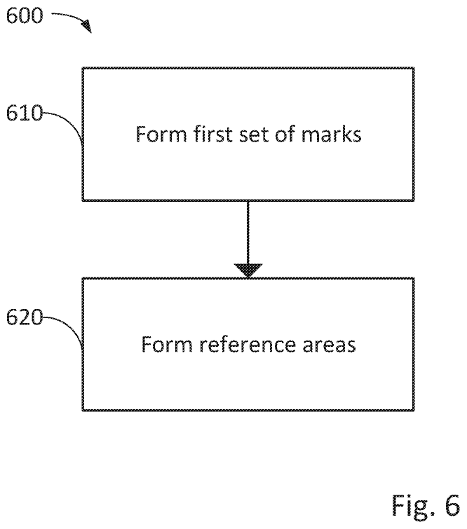

FIG. 6 illustrates a method 600 according to some examples. A first set of marks is formed on a print target 610. A plurality of reference areas are formed on the surface of the print target 620 such that a plurality of gaps between the plurality of reference areas are formed and that the plurality of reference areas at least partially cover the first set of marks. The first set of marks are a first color; the reference areas are a second color, the second color different to the first color. The reference areas are formed with a printing fluid such that the first set of marks underneath the reference areas are substantially undetectable; and the remainder of the first set of marks are substantially detectable in one of the plurality of gaps indicates a measure of alignment between the first set of marks and the plurality of reference areas. Each mark of the first set of marks has a width W₁, and wherein each of the plurality of gaps has a width W₂, wherein W₂ is approximately equal to W₁.

In some examples forming the first set of marks on the print target 610 may comprise printing the first set of marks on the print target. In some examples, forming the plurality of reference areas on the print target may comprise printing a plurality of reference areas on the print target.

In some examples the method 600 may further comprise determining a value corresponding to the measure of alignment between the first set of marks and the plurality of reference areas. In some examples the method 600 may further comprise adjusting, based on the determined value at least one of a position of a first print device, and a second print device. The first print device to print the first set of marks, and the second print device to print the plurality of reference areas.

In some examples after printing the plurality of reference areas 620, a single one of the first set of marks is substantially detectable in the gaps between the reference areas and the remainder of the first set of marks are substantially undetectable. In some examples after printing the plurality of reference areas 620, a single one of the first set of marks is detectable inside one of the plurality of gaps and the remainder of the first set of marks are substantially undetectable.

In some examples the first set of marks have a spacing S₁ and the plurality of reference areas have a spacing S₂. In some examples the first set of marks may be regularly and/or periodically spaced. In some examples the plurality of reference areas may be regularly and/or periodically spaced.

The overall length of the alignment pattern when formed may be equal to nS₁ where n is the number of marks of the first set of marks. S₂ may be chosen such that nS₁=(n−1)S₂. In some examples S₁ may be in the range 30-50 mm, and S₂ may be within the range 28-48 mm. In some examples W₁ may be within a range of 1-2 mm, and W₂ may be within a range of 1-2 mm, although the ranges are not limited to the aforementioned values

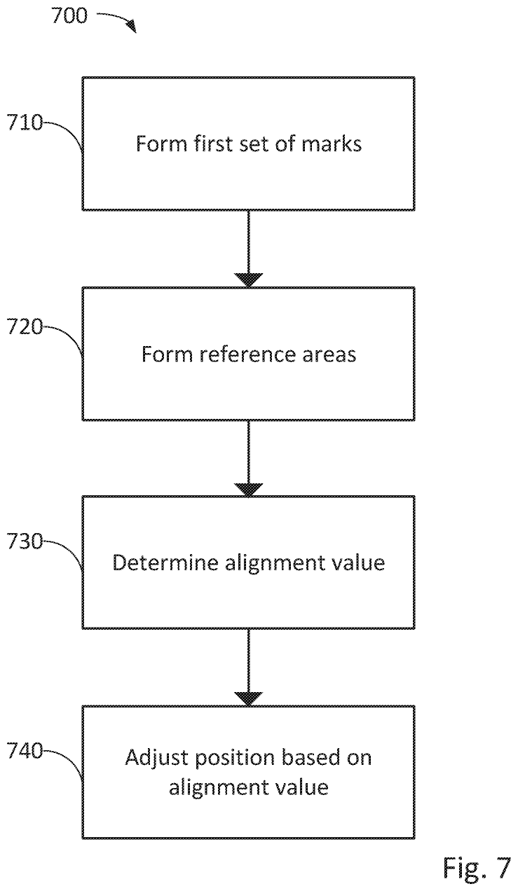

FIG. 7 illustrates a method 700 in accordance with some examples. A first set of marks on a print target is formed 710. A plurality of reference areas are formed on the print target 720, wherein the plurality of reference areas have a plurality of gaps between the reference areas. The first set of marks are formed of a first color; the reference areas are formed of a second color, the second color different to the first color. The reference areas are formed with a print fluid such that the first set of marks underneath the reference areas are substantially undetectable; and one of the first set of marks substantially detectable in one of the plurality of gaps indicates a measure of alignment between the first set of marks and the plurality of reference areas. A value corresponding to the measure of alignment between the first set of marks and the plurality of reference areas is determined 730. Based on the determined value at least one of a position of a first print device, and a second print device 740 is adjusted. The first print device to form the first set of marks, and the second print device to form the plurality of reference areas.

In some examples the method 700 may be repeated until the magnitude of the misalignment is less than an acceptable threshold value.

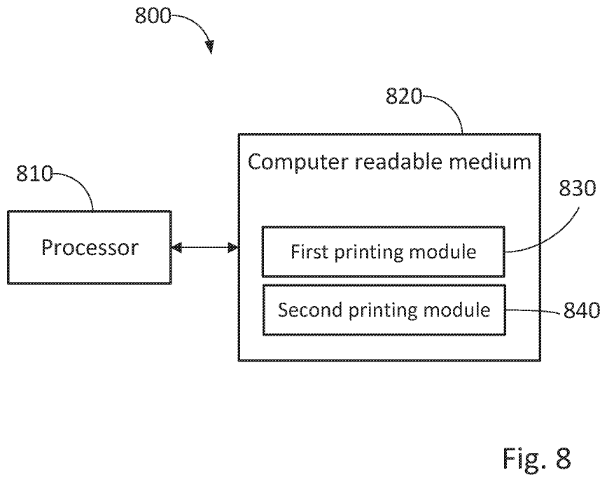

FIG. 8 illustrates a system 800 according to some examples. The system may comprise a processor 810 and a computer readable medium 820. The computer readable medium 820 stores units or modules, with each unit or module including instructions that, when executed, cause the processor 810 or other processing device to perform particular operations. The computer readable medium 820 may include a first printing module 830, and a second printing module 840. The units or modules of the computer readable medium 820 may cause a processing device 810 to operate in accordance with any of the examples described herein. The computer readable medium may be a non-volatile computer readable medium. For example, the computer readable medium may be a hard disc, optical disc, non-volatile memory, etc.

The first printing module 830 may contain instructions to allow a first print device to print a first set of marks. The second printing module 840 may contain instructions to allow a second print device to print a plurality of reference areas. The plurality of reference areas may have a plurality of gaps between the reference areas. The first set of marks are formed of a first color; the reference areas are formed of a second color, the second color different to the first color. The reference areas are formed such that the first set of marks underneath the reference areas are substantially undetectable; and one of the first set of marks substantially detectable in one of the plurality of gaps indicates a measure of alignment between the first set of marks and the plurality of reference areas. A value corresponding to the measure of alignment between the first set of marks and the plurality of reference areas may be determined by an alignment verification module (not shown in FIG. 8).

In an example, the first printing module 830 may contain instructions to allow a first print device to print first set of marks of a first color. The second printing module 840 may contain instructions to allow a second print device to print a plurality of opaque areas at least partially covering the first set of marks being the opaque areas to work as reference areas, being the opaque areas of a second color different to the first color and the opaque areas comprising a set of gaps between areas. The opaque areas may have an opacity such that the first set of marks that are underneath the opaque areas are substantially undetectable or, at least, less detectable than when no opaque area is printed over them and/or when the marks are in the gaps between opaque areas. An alignment of a printing device is to be performed by an alignment verification module upon measuring at least a distance between at least one of the first set of marks and at least one of the opaque areas.

In some examples system 800 may also comprise a print apparatus, the print apparatus including at least a first printing device and a second printing device. In some examples alignment information may be used to change the relative position of the first printing device and the second printing device, or changes may be made to the image to be printed to correct the misalignment.

In some examples the first print device and/or the second print device may be a print head. In some examples, a print target may be a substrate, such as paper, card or any other material suitable to be printed onto. A print target is not limited to two-dimensional print target and may include three-dimensional print target.

In some examples the printing fluid may comprise an ink and/or a non-marking fluid such as an overcoat. A fluid may be any substance that continually deforms under an applied shear stress (i.e. flows). In some examples a fluid may be a liquid, gas, a suspension of particles in a liquid, or a plurality of solids.

In some examples, a mark being detectable may refer to the mark being detectable by optical means. In some examples the mark may be detected by an optical sensor. In some examples, a mark may be undetectable if it is not possible to detect the mark using an optical sensor.

Throughout the description and claims of this specification, the words “comprise” and “contain” and variations of them mean “including but not limited to”, and they are not intended to (and do not) exclude other components, integers or steps. Throughout the description and claims of this specification, the singular encompasses the plural unless the context otherwise suggests. In particular, where the indefinite article is used, the specification is to be understood as contemplating plurality as well as singularity, unless the context suggests otherwise.

Features, integers or characteristics described in conjunction with a particular aspect or example are to be understood to be applicable to any other aspect or example described herein unless incompatible therewith. All of the features disclosed in this specification (including any accompanying claims, abstract and drawings), and/or all of the operations of any method or process so disclosed, may be combined in any combination, except combinations where at least some of such features and/or operations are mutually exclusive. Examples are not restricted to the details of any foregoing examples. The Examples may extend to any novel one, or any novel combination, of the features disclosed in this specification (including any accompanying claims, abstract and drawings), or to any novel one, or any novel combination, of the operations of any method or process so disclosed.

The reader's attention is directed to all papers and documents which are filed concurrently with or previous to this specification in connection with this application and which are open to public inspection with this specification, and the contents of all such papers and documents are incorporated herein by reference.

1. A print target comprising an alignment pattern on a surface of the media, the alignment pattern comprising;
a first set of marks of a first colour, and a plurality of reference areas covering at least partially the first set or marks, the reference areas having a plurality of gaps, the reference areas a second colour;
wherein the second colour is different to the first colour;
the reference areas are formed with a printing fluid so that the first set of marks underneath the reference areas are less detectable than a remainder of the first set of marks; and one of the remainder of the first set of marks more detectable in one of the plurality of gaps indicates a measure of alignment between the first set of marks and the reference areas.

2. The media according to claim 1, wherein the remainder of the first set of marks comprises a single mark, such that of the first set of marks only one of the first set of marks is more detectable in the plurality of gaps.

3. The media according to claim 1, wherein each first mark of the first set of marks has a width W1, and wherein each of the plurality of gaps has a width W2, wherein W2 is approximately equal to W1.

4. The media according to claim 1, wherein each of the reference areas have a level of opacity such that the first set of marks underneath the reference areas are less detectable than the remainder of the first set of marks.

5. The media according to claim 1, wherein the first set of marks and the plurality of gaps align according to a Vernier pattern.

6. The media according to claim 1, wherein the second colour is the substantially the same colour as the surface of the media.

7. The media according to claim 1, wherein the second colour is white.

8. A method comprising:
forming a first set of marks on a surface of a media;
forming a plurality of reference areas on the surface of the media, the plurality of reference areas covering at least partially the first set of marks and the reference areas having a plurality of gaps; each mark of the first set of marks has a width W1, and wherein each of the plurality of gaps has a width W2, wherein W2 is approximately equal to W1;
wherein the first set of marks are a first colour;
the reference areas are a second colour, the second colour different to the first colour;
the reference areas are formed with a printing fluid such that the first set of marks underneath the reference areas are less detectable than a remainder of the first set of marks; and
one of the remainder of the first set of marks more detectable in one of the plurality of gaps indicates a measure of alignment between the first set of marks and the plurality of reference areas.

9. The method according to claim 8, further comprising determining a value corresponding to the measure of alignment between the first set of marks and the plurality of reference areas.

10. The method according to claim 9, further comprising adjusting, based on the determined value a relative position of a first print device and a second print device, the first print device to print the first set of marks; and the second print device to print the reference areas.

11. The method according to claim 8, wherein of the first set of marks only one of the first set of marks is more detectable.

12. The method according to claim 8, wherein the first set of marks and the plurality of reference areas form a Vernier pattern.

13. The method according to claim 8, wherein the second colour is the substantially the same colour as the surface of the media.

14. A printing system to perform the method of claim 8.

15. A computer readable medium storing instructions, that when executed, cause a processor to perform the method of claim 8, or cause a printing system to produce a media according to claim 1.
